(19) United States
(12) Patent Application Publication
(10) Pub. No.: US 2024/0191373 A1
(43) Pub. Date: Jun. 13, 2024

(54) CATALYST INK COMPOSITION AND CATALYST COATED MEMBRANES FOR ELECTROLYSIS

(71) Applicant: UOP LLC, Des Plaines, IL (US)

(72) Inventors: Chunqing Liu, Arlington Heights, IL (US); Xueliang Dong, Schaumburg, IL (US); Dennis F. van der Vliet, Skokie, IL (US); Saad Intikhab, Des Plaines, IL (US); Shurong Yang, Naperville, IL (US)

(21) Appl. No.: 18/064,023

(22) Filed: Dec. 9, 2022

(51) Int. Cl. C25B 11/075; C25B 11/055; C25B 13/04

(52) U.S. Cl. CPC C25B 11/075; C25B 11/055; C25B 13/04

(57) ABSTRACT

Catalyst ink formulas for the preparation of CCMs are described. The catalyst ink formulas comprise a catalyst, an ionomer, a solvent, and a porogen soluble in the solvent. The catalyst ink formula may also comprise an additive, such as an electron conductive polymer. The anode catalyst coating layer or both the anode and the cathode catalyst coating layers prepared from the catalyst ink formula comprises uniformly distributed nanopores that allow easy gas removal and uniform water feed distribution, which will avoid or reduce the direct energy losses for the electrolyzers. Catalyst coated membranes and methods of making a catalyst coated membranes are also described.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction: 2H₂O→2H₂+O₂ (1)

Oxidation reaction at anode for PEMWE: 2H₂O→O₂+4H⁺+4e⁻ (2)

Reduction reaction at cathode for PEMWE: 2H⁺+2e⁻→H₂ (3)

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%.

Reduction reaction at cathode for AEMWE: 4H₂O+4e⁻→2H₂+4OH⁻ (4)

Oxidation reaction at anode for AEMWE: 4OH⁻→2H₂O+O₂+4e⁻ (5)

AEMWE has an advantage over PEMWE because it permits the use of less expensive platinum metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are membrane hydroxyl ion conductivity and stability, as well as lack of understanding of how to integrate catalysts into AEM systems. Research on AEMWE in the literature has been focused on developing electrocatalysts, AEMs, and understanding the operational mechanisms with the general objective of obtaining a high efficiency, low cost and stable AEMWE technology.

In the PEM-WE and AEM-WE systems, several components are integrated to produce green H₂, including current collector plates, bipolar plates (BPs), two porous transport layers (PTL), a three-layer membrane electrode assembly (MEA) consisting of a membrane, an anode layer, and a cathode layer. In some cases, a five-layer MEA including a membrane, an anode layer, a cathode layer, and two PTL layers is used in the PEM-WE and AEM-WE systems when the catalysts are coated on one surface of the PTL. Among the main components, MEA is the most important component as the electrochemical water electrolysis reaction occurs in the MEA. There are two main methods for MEA fabrication including catalyst-coated substrates (CCSs) and catalyst-coated membranes (CCMs). Different MEA fabrication techniques and different catalyst loadings on the anode and/or cathode coating layers often result in different performances.

The membrane is one of the key components in the MEA and is an important driver for safety and performance. Some important properties for membranes for membrane electrolysis include high conductivity, high ionic permeability, high ionic exchange capacity (for ion-exchange membrane), high ionic/H₂ and O₂ selectivity (low H₂ and O₂ permeability/crossover), low price, low area resistance to minimize efficiency loss resulting from ohmic polarization, high resistance to oxidizing and reducing conditions, being chemically inert at a wide pH range, high thermal stability together with high proton conductivity, and high mechanical strength (thickness, low swelling).

The anode in the MEA for an electrochemical cell coated either on one surface of the membrane on one surface of the PTL is the electrode at which the predominant reaction is oxidation (e.g., the water oxidation/oxygen evolution reaction electrode for a water electrolyzer). The cathode in the MEA for an electrochemical cell coated either on the other surface of the membrane on one surface of the PTL is the electrode at which the predominant reaction is reduction (e.g., the proton reduction/hydrogen evolution reaction electrode for a water electrolyzer). Both anode and cathode are key components in the MEA. Typically, unsupported or supported iridium (Ir) based scarce platinum group electrocatalysts are used for the oxygen evolution reaction (OER) on the anode and carbon supported platinum electrocatalyst (Pt/C) is used for the hydrogen evolution reaction (HER) on the cathode for PEM-WE. Significant reduction of the platinum group catalyst loading on the catalyst coating layer will be required with the increase of the GW-scale PEM-WE installation projects. Methods for reducing the loading of the platinum group catalysts include supporting the platinum group metals or metal oxides such as IrO₂ on high surface area support materials, designing the catalyst with unique structures, such as nanostructured thin films, nanowires or core-shell structures, using advanced catalyst layer coating techniques, and reducing the thickness of the catalyst coating layer.

However, reducing Ir-based catalyst loading in the anode coating layer normally will result in the oxygen evolution reaction (OER) kinetic penalty for PEM-WE. Studies on the CCM fabrication method have focused on the effects of a catalyst ink on the manufacturing and performance of CCM in water electrolysis. The catalyst ink used for the formation of the anode and cathode coating layers on the membrane surfaces or on the PTL is important to provide the MEA with high catalyst activity, high proton or hydroxide conductivity, and high electrical conductivity in the catalyst layers.

The elimination or mitigation of the direct and indirect energy losses arising from gas bubble formation in the catalyst coating layers in the electrolyzers would provide significant energy savings for water electrolysis. Bubble formation on the electrodes may involve four steps including bubble nucleation, bubble growth, bubble detachment, and mass transport of the bubbles away from the electrodes.

Significant advances are needed in cost-effective, high performance, stable catalysts, catalyst ink formulas, membrane materials, as well as other cell stack components for water electrolysis with a wide range of applications in renewable energy systems.

### BRIEF DESCRIPTION OF THE DRAWINGS

FIG. 1 is an illustration of one embodiment of a PEMWE cell.

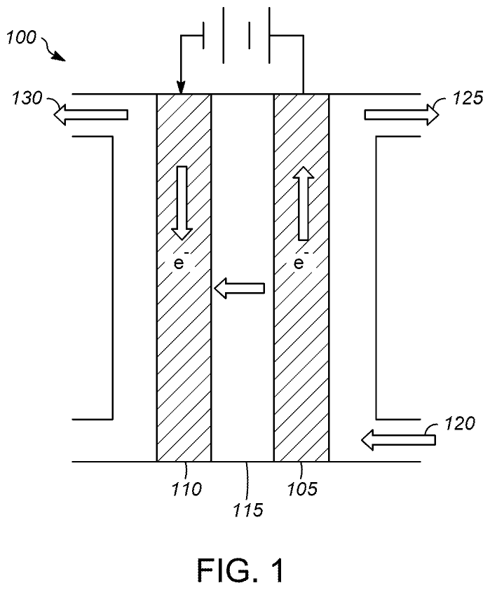

FIG. 2 is an illustration of one embodiment of a AEMWE cell.

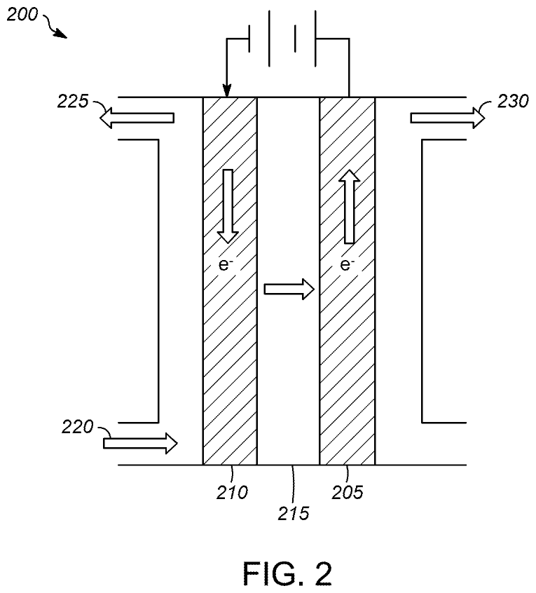

FIG. 3 is a graph showing the polarization curves of water electrolysis cells made using MEAs made with and without the use of a porogen.

### DESCRIPTION OF THE INVENTION

A novel catalyst ink formula for the preparation of CCMs was developed. The anode catalyst coating layer or both the anode and the cathode catalyst coating layers on the CCMs prepared from the present catalyst ink formula comprises uniformly distributed nanopores that allow easy gas removal and uniform water feed distribution, which will avoid or reduce the direct energy losses for the electrolyzers. The catalyst ink formula for the preparation of CCMs may comprise a catalyst, an ionomer, a solvent, and a porogen soluble in the solvent. The catalyst ink formula may also comprise an additive, such as an electron conductive polymer. The creation of a nanoporous morphology on the anode or both the anode and the cathode via the use of the present catalyst ink formula comprising porogens soluble in a solvent accelerates the gas release from the electrodes and the uniform water feed distribution within the anode catalyst coating layer.

The porogen can be incorporated into the anode ink formula, the cathode ink formula, or both the anode and the cathode ink formulas. The porogen can be removed from the final CCMs by soaking in a solvent, an acidic solution for PEM-based CCMs, or a basic solution for AEM-based CCMs to generate nanopores before the CCMs are utilized in the electrolyzers. The porogen can also be removed from the final CCMs by washing with a solvent, an acidic solution for PEM-based CCMs, or a basic solution for AEM-based CCMs to generate nanopores before the CCMs are utilized in the electrolyzers. The nanopores have a pore diameter of less than 200 nm, or less than 175 nm, or less than 150 nm, or less than 125 nm, or less than 100 nm.

Suitable porogens include, but are not limited to, glycerol, glycine, ethylene glycol, poly(ethylene glycol), poly(ethylene oxide) (PEO), poly(propylene oxide) (PPO), co-block-poly(ethylene oxide)-poly(propylene oxide) (PEO-PPO), tri-block-poly(propylene oxide)-poly(ethylene oxide)-poly(propylene oxide) (PPO-PEO-PPO), sorbitol, polyvinylpyrrolidone (PVP), polyacrylic acid (PAA), diethylene glycol, sulfosuccinic acid, tetradecyltrimethylammonium bromide, tetramethylammonium bromide, tetradecyltrimethylammonium acetate, tetramethylammonium acetate, or combinations thereof.

The porogen can be removed from the final CCMs by soaking in a solvent, an acidic solution for PEM-based CCMs, or a basic solution for AEM-based CCMs at a temperature in the range of about 20° C. to about 120° C., or about 20° C. to about 80° C., or about 20° C. to about 40° C. for about 10 min to about 48 h, or about 30 min to 24 h, or about 2 h to 12 h to generate nanopores before the CCMs are utilized in the electrolyzers. The porogen can also be removed from the final CCMs by washing with a solvent, an acidic solution for PEM-based CCMs, or a basic solution for AEM-based CCMs at a temperature in the range of about 20° C. to about 80° C. or about 20° C. to about 40° C. for about 10 min to about 4 h, or about 30 min to 2 h to generate nanopores before the CCMs are utilized in the electrolyzers.

Suitable solvents for the removal of the porogen include, but are not limited to, water, alcohol, acetone, methyl ethyl ketone, an ether such as diethyl ether or di-n-propyl ether, tetrahydrofuran, 1,3-dioxolane, methyl acetate, ethyl acetate, or combinations thereof. Suitable acidic solutions for the removal of the porogen include, but are not limited to, an HCl solution or a H₂SO₄ solution. Suitable basic solutions for the removal of the porogen include, but are not limited to, solutions of KOH, KHCO₃, K₂CO₃, Na₂CO₃, NaHCO₃, or NaOH.

The catalyst can be any catalyst suitable for electrolysis. Suitable cathode catalysts include, but are not limited to, platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof.

Suitable anode catalysts include, but are not limited to, iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof.

The cathode and/or anode catalysts can be supported or unsupported.

Suitable high surface area support materials for the preparation of the supported catalysts include titanium oxide, aluminum oxide, silicon dioxide, zirconium dioxide, yttrium oxide, cerium oxide, cerium dioxide, lanthanum oxide, tin oxide, tungsten oxide, molybdenum oxide, niobium oxide, tantalum oxide, tin oxide, and anion and cation doped varieties of these oxides, including, but not limited to, fluoro-doped tin oxide, indium-doped and antimony-doped tin oxide and mixtures thereof.

The polymeric ionomer as the binder for the catalyst particles creates proton (H′) or hydroxide (OH) transport pathways between the membrane and the reaction sites within the electrode catalyst coating layer. The polymeric ionomer improves the utilization of the electrocatalyst particles while reducing the internal resistance. The polymeric ionomer is desirably insoluble in water and has high H⁺ or OH⁻ conductivity, high chemical, oxidative, and thermal stabilities, and high solubility or dispersibility in the solvents. The polymeric ionomer can be fluorinated ionomers, such as Nafion®, non-fluorinated ionomers, or a hydroxide-conductive polymeric ionomer, or combinations thereof. In some embodiments, the chemical structure of the polymeric ionomer is similar to the membrane in the MEA, which allows low interfacial resistance and similar expansion in contact with water to avoid delamination, but higher O₂ and H₂ permeabilities than the membrane.

Suitable proton-conductive fluorinated polymeric ionomers include, but are not limited to, perfluorosulfonic acid (PFSA) polymers such as Nafion®, Flemion®, Aquivion®, Aciplex®, NEOSEPTA®-F, Fumapem®, sulfonated trifluorostyrene-trifluorostyrene copolymer, sulfonated polystyrene-poly(vinylidene fluoride) copolymer, or combinations thereof. Suitable proton-conductive non-fluorinated polymeric ionomers include, but are not limited to, sulfonated polysulfone, cross-linked sulfonated polysulfone, sulfonated poly(phenylene sulfone), sulfonated phenylated poly(phenylene), sulfonated polystyrene, sulfonated polyethersulfone, cross-linked sulfonated polyethersulfone, sulfonated polyether ether ketone, cross-linked sulfonated polyether ether ketone, or combinations thereof. Suitable hydroxide-conductive polymeric ionomers include, but are not limited to, alkyl ammonium polyfluorene ionomer, poly(aryl piperidinium) ionomer, benzyl trimethylammonium-functionalized high-density polyethylene, N-heterocyclic and alkyl ammonium-based polyphenylene, benzyl trimethylammonium-functionalized poly(ethylene-co-tetrafluoroethylene), or combinations thereof.

A solvent may be used to disperse the catalyst particles, the polymeric ionomer, and the porogen to form a uniform catalyst ink. The solvents desirably have low boiling points so that they can be removed easily during or after the ink coating process. Suitable solvents include, but are not limited to, water, an alcohol, acetone, methyl ethyl ketone, an ether such as diethyl ether or di-n-propyl ether, tetrahydrofuran, 1,3-dioxolane, methyl acetate, ethyl acetate, dimethyl sulfoxide, dimethylacetamide, dimethylformamide, or combinations thereof. Suitable alcohols include, but are not limited to, methanol, ethanol, 1-propanol, 2-propanol, 1-butanol, 2-butanol, iso-butanol, or tert-butanol, or combinations thereof.

The membrane can be an ionically conductive membrane.

The ionically conductive membrane can be a proton-exchange membrane (PEM) or an anion exchange membrane (AEM). The ionically conductive membrane can be a PEM or a polyelectrolyte multilayer coated PEM comprising a PEM and a polyelectrolyte multilayer coating on a surface of the PEM, wherein the polyelectrolyte multilayer coating comprises alternating layers of a polycation polymer and a polyanion polymer, and wherein the polycation polymer layer is in contact with the PEM. The ionically conductive membrane can also be an AEM or a polyelectrolyte multilayer coated AEM comprising an AEM and a polyelectrolyte multilayer coating on a surface of the AEM, wherein the polyelectrolyte multilayer coating comprises alternating layers of a polycation polymer and a polyanion polymer, and wherein the polycation polymer layer is in contact with the AEM.

The polyelectrolyte multilayer coated PEM comprises a polycation polymer layer deposited on and in contact with the PEM. There can be one, two, three, four, five, or more sets of alternating polycation polymer and polyanion polymer layers on one or both sides of the PEM. The polyelectrolyte multilayer coated AEM comprises a polyanion polymer layer deposited on and in contact with the AEM. There can be one, two, three, four, five, or more sets of alternating polycation polymer and polyanion polymer layers on one or both sides of the AEM. The top layer of the polyelectrolyte multilayer coating can be either a polycation polymer layer or a polyanion polymer layer. See U.S. Ser. No. 17/451,227 filed Oct. 18, 2021, entitled Polyelectrolyte Multilayer Coated Proton Exchange Membrane for Electrolysis and Fuel Cell Application, which is incorporated herein in its entirety.

The polyelectrolyte multilayer coating may be formed using a layer-by-layer self-assembly method. The layer-by-layer self-assembly may be achieved by adsorption, electrostatic interactions, covalent bonds, hydrogen bonds, van der Waals forces, hydrophobic interactions, or combinations thereof, for example. The methods for the formation of polyelectrolyte multilayer coating via layer-by-layer self-assembly may be selected from, but are not limited to, dip coating, spray deposition, centrifugal deposition, electrodeposition, meniscus/slot die coating, brushing, roller coating, metering rod/Meyer bar coating, knife casting, and the like.

The choice of the fabrication method depends on the polycation and polyanion to be assembled, the time required for the layer-by-layer self-assembly, and the shape of the cation exchange membrane that the polyelectrolyte multilayer coating will be deposited on. The first polyelectrolyte layer is formed by the adsorption (for example) of a polycation or polyanion on one or both surfaces of the PEM or AEM possessing opposite charges. Subsequently, the second layer of the polyelectrolyte with charges opposite from the first layer of the polyelectrolyte is deposited on the first layer of the polyelectrolyte to form one set of alternating layers on the PEM or AEM. A nanostructured polyelectrolyte multilayer coating with n sets of alternating layers on one or both surfaces of the PEM results in a new proton-exchange membrane of PEM (or AEM)/(polycation-polyanion)ₙ or (polyanion-polycation)ₙ/PEM (or AEM)/(polycation-polyanion)ₙ, respectively. The increase in polyelectrolyte multilayer thickness depends on the number of layers deposited and can be either linear or non-linear. Several parameters, such as ionic strength, pH, temperature, polyelectrolyte structure, concentration, and charge density, can be adjusted during the layer-by-layer self-assembly process. The oppositely changed polyelectrolyte layers are deposited on the surface of the PEM or AEM. The polyelectrolyte multilayers are insoluble and thermally and chemically stable.

The polyanion polymer in the polyelectrolyte multilayer coating may be different from the ion exchange polymer in the PEM or AEM.

The PEM comprises a cation exchange polymer or a mixture of a cation exchange polymer and an inorganic filler comprising covalently bonded acidic functional groups. The PEM in the polyelectrolyte multilayer coated PEM comprises —SO₃⁻, —COO⁻, —PO₃²⁻, or —PO₃H⁻ cation exchange functional groups with negative ionic charges. The cation exchange polymer in the PEM may be selected from, but is not limited to, a perfluorosulfonic acid (PFSA) polymer such as Nafion®, Flemion®, Fumion®, Aciplex®, Aquivion®, Fumapem® FS, BAM®, or NEOSEPTA®-F, a cross-linked perfluorinated cation-exchange polymer, a partially fluorinated polymer, a cross-linked partially fluorinated cation-exchange polymer, a non-fluorinated hydrocarbon polymer, a cross-linked non-fluorinated hydrocarbon cation-exchange polymer, or combinations thereof. The PEM has high mechanical strength, good chemical and thermal stability, and good proton conductivity. The polyelectrolyte multilayer coated PEM has low membrane area specific resistance, low swelling, significantly reduced H₂ and O₂ crossover, and enhanced proton conductivity compared to the PEM without the polyelectrolyte multilayer coating.

The PEM for the preparation of the polyelectrolyte multilayer coated PEM may be the composite proton conductive membrane described in U.S. patent application Ser. No. 17/162,421, filed on Jan. 29, 2021, entitled Composite Proton Conductive Membranes, which is incorporated herein by reference in its entirety. That application disclosed a new type of composite proton conductive membrane comprising an inorganic filler having covalently bonded acidic functional groups and a high surface area of at least 150 m²/g, and a water insoluble ionically conductive polymer. The deposition of the polyelectrolyte multilayer coating on the composite proton conductive membrane resulted in reduced membrane swelling, significantly reduced H₂ and O₂ crossover, and enhanced proton conductivity compared to the composite proton conductive membrane without the polyelectrolyte multilayer coating.

The inorganic filler comprising covalently bonded acidic functional groups in the cation exchange membrane may be selected from, but is not limited to, silica gel, precipitated silica, fumed silica, colloidal silica, alumina, silica-alumina, zirconium oxide, molecular sieve, metal-organic framework, zeolitic imidazolate framework, covalent organic framework, or a combination thereof, and wherein the filler may comprise both covalently bonded acidic functional groups and a high surface area of 150 m²/g or higher, or 300 m²/g or higher, or 400 m²/g or higher. Molecular sieves have framework structures which may be characterized by distinctive wide-angle X-ray diffraction patterns. Zeolites are a subclass of molecular sieves based on an aluminosilicate composition. Non-zeolitic molecular sieves are based on other compositions such as aluminophosphates, silico-aluminophosphates, and silica. Molecular sieves can have different chemical compositions and different framework structure. The molecular sieves can be microporous or mesoporous molecular sieves and need to be stable in aqueous solution under pH of less than 6. The acidic functional groups covalently bonded to the inorganic fillers may be selected from, but are not limited to, —H₂PO₃, —R—H₂PO₃, —SO₃H, —R—SO₃H, —COOH, —R—COOH, —C₆H₅OH, —R—C₆H₅OH, or a combination thereof, wherein R represents a linear alkyl group, a branched alkyl group, a cycloalkyl group, an organoamino group, an acid group-substituted organoamino group, or an aryl group and the number of carbon atoms in these groups is preferably 1 to 20, more preferably 1 to 10. The inorganic fillers may be in the form of, but are not limited to, particles, fine beads, thin plates, rods, or fibers. The size of the inorganic filler is in a range of about 2 nm to about 200 μm, or in a range of about 10 nm to about 100 μm, or in a range of about 50 nm to about 80 μm. In some embodiments, the inorganic filler is aminopropyl-N,N-bis(methyl phosphonic acid)-functionalized silica gel such as SilicaMetS® AMPA, aminopropyl-N,N-bis(methyl phosphonic acid)-functionalized fumed silica, n-propyl phosphonic acid-functionalized silica gel, n-propyl phosphonic acid-functionalized fumed silica, p-toluenesulfonic acid-functionalized silica gel, p-toluenesulfonic acid-functionalized fumed silica, 4-ethylbenzenesulfonic acid-functionalized silica gel such as SilicaBond® Tosic Acid, 4-ethylbenzenesulfonic acid-functionalized fumed silica, n-propyl sulfonic acid-functionalized silica gel, n-propyl sulfonic acid-functionalized fumed silica, or combinations thereof.

Suitable cation exchange polymers for the preparation of PEMs include, but are not limited to, a perfluorinated sulfonic acid-based polymer, a perfluorinated carboxylic acid polymer, a sulfonated aromatic hydrocarbon polymer, a cross-linked sulfonated aromatic hydrocarbon polymer, or combinations thereof. Suitable cation exchange polymers include, but are not limited to, a copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, a copolymer of perfluoro-3-oxa-4-pentene-sulfonic acid and 2,2,4-trifluoro-5-trifluoromethoxy-1,3-dioxole, sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, cross-linked sulfonated poly(vinyl toluene), or combinations thereof.

The first layer deposited on one or both surfaces of the PEM possessing negative ionic charges should be a polycation polymer layer having positive ionic charges, opposite from those on the cation exchange membrane, which leads to the formation of a stable coating as the first part of the first polyelectrolyte bilayer via electrostatic interactions between the cation exchange polymer of the PEM and the polycation deposited on the surface of the PEM. A polyanion polymer with opposite charges is then deposited on the surface of the first polycation polymer coating layer via electrostatic interactions to form the second part of the first polyelectrolyte bilayer. Polyelectrolyte multilayers of either PEM/(polycation-polyanion), or polyanion-polycation)ₙ/PEM/(polycation-polyanion)ₙ can be formed following the same alternating deposition process. The thickness of each layer of the polyanion or polycation is less than 50 nm, or less than 20 nm, or less than 10 nm, or less than 5 nm. The polyanion polymer in the polyelectrolyte multilayers has negative charges and can be the same or different from the cation exchange polymer in the PEM, but the polyanion polymer cannot be the first polyelectrolyte layer deposited on the surface of the PEM having negative charges. The polyanion polymer suitable for the preparation of the polyelectrolyte multilayer coated PEM has similar or higher proton conductivity than the PEM and has similar or lower H₂ and O₂ permeabilities than the PEM. However, the polyanion polymer and the polycation polymer may be soluble in aqueous solutions, which makes the membranes prepared from either the polyanion polymer or polyanion polymer unsuitable for water electrolysis or fuel cell applications. The polyelectrolyte multilayers deposited on one or both surfaces of the PEM via layer-by-layer self-assembly are not only insoluble and thermally and chemically stable, but also have significantly reduced swelling and H₂ and O₂ crossover of the cation exchange membrane, and enhanced proton conductivity compared to the PEM for water electrolysis or fuel cell applications.

The polycation polymers suitable for the preparation of the polyelectrolyte multilayer coated PEM or AEM include, but are not limited to protonated chitosan; an amine based linear, hyperbranched, or dendritic polycation polymer selected from the group consisting of polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly(4-vinylpiperidine hydrochloride), poly(diallyldimethylammonium chloride), poly(acrylamide-co-diallyldimethylammonium chloride), poly(diallyl methyl amine hydrochloride), a copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(l-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate]; or combinations thereof.

The polyanion polymers suitable for the preparation of the polyelectrolyte multilayer coated PEM or AEM include but, are not limited to, a sulfonated hydrocarbon polymer, poly(acrylic acid), poly(sodium phosphate), or a negatively charged polysaccharide polyanion polymer, or combinations thereof. Suitable sulfonated hydrocarbon polymers include, but are not limited to, sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated polystyrene, sulfonated poly(vinyl toluene), poly(acrylic acid), poly(vinylsulfonic acid sodium), poly(sodium phosphate), or combinations thereof. Suitable negatively charged polysaccharide polyanion polymers include, but are not limited to, sodium alginate, potassium alginate, calcium alginate, ammonium alginate, alginic acid, sodium hyaluronate, potassium hyaluronate, calcium hyaluronate, ammonium hyaluronate, hyaluronic acid, κ-carrageenan, λ-carrageenan, ι-carrageenan, carboxymethyl curdlan, sodium carboxymethyl curdlan, potassium carboxymethyl curdlan, calcium carboxymethyl curdlan, ammonium carboxymethyl curdlan, carboxymethyl cellulose, sodium carboxymethyl cellulose, potassium carboxymethyl cellulose, calcium carboxymethyl cellulose, ammonium carboxymethyl cellulose, or combinations thereof.

Another aspect is a catalyst coated membrane. In one embodiment, the catalyst coated membrane comprises a membrane; and a layer of catalyst on one surface of the membrane, where the catalyst layer comprises the catalyst, an ionomer, and optionally an additive; wherein the catalyst layer is formed from a catalyst ink comprising a catalyst: an ionomer; a solvent; a porogen soluble in the solvent; and optionally an additive.

There can be a layer of catalyst on the other side of the membrane. The layer of catalyst on the two sides can be the same or different.

The catalyst, ionomer, solvent, porogen, and additive are as described above.

Another aspect of the invention is a method of making a catalyst coated membrane. In one embodiment, the method comprises: coating a layer of catalyst ink on a first surface of a membrane to form a coated membrane, drying the layer of catalyst ink to form a catalyst layer on the first surface of the membrane; and removing the porogen from the catalyst layer to create nanopores in the catalyst layer. The catalyst ink comprises a catalyst, an ionomer, a porogen, a solvent, and optionally an additive. Suitable coating methods of application include, but are not limited to, spray coating, comma roll coating, meniscus/slot die coating, gravure coating, brushing, roller coating, metering rod/Mayer rod coating, knife casting, and the like.

In some embodiments, removing the porogen from the catalyst layer comprises soaking the coated membrane in a solvent, an acidic solution for PEM-based CCMs, or a basic solution for AEM-based CCMs at a temperature in the range of about 20° C. to about 120° C. or about 20° C. to about 80° C., or about 20° ° C. to about 40° C. for about 10 min to about 48 h, or about 30 min to 24 h, or about 2 h to 12 h to generate nanopores before the CCMs are utilized in the electrolyzers. The porogen can also be removed from the catalyst layer by washing the coated membrane with a solvent, an acidic solution for PEM-based CCMs, or a basic solution for AEM-based CCMs at a temperature in the range of about 20° C. to about 80° C. or about 20° C. to about 40° C. for about 10 min to about 4 h, or about 30 min to 2 h to generate nanopores before the CCMs are utilized in the electrolyzers. Suitable solvents, acidic solutions, and basic solutions for the removal of the porogen are as described above.

In some embodiments, the method further comprises coating a layer of catalyst on a second surface of the membrane.

Another aspect of the invention is a membrane electrode assembly. In one embodiment, the membrane electrode assembly comprises an ionically conductive membrane, a first porous transport layer adjacent to a first side of the ionically conductive membrane; and a second porous transport layer adjacent to a second side of the ionically conductive membrane. There is an anode between the first side of the ionically conductive membrane and the first porous transport layer, the anode comprising an anode catalyst coating layer on the first side of the ionically conductive membrane adjacent to the first porous transport layer, or on a first side of the first porous transport layer adjacent to the first side of the ionically conductive membrane, or both; and a cathode between the second side of the ionically conductive membrane and the second porous transport layer, the cathode comprising a cathode catalyst coating layer on the second side of the ionically conductive membrane adjacent to the second porous transport layer, or on a first side of the second porous transport layer adjacent to the second side of the ionically conductive membrane, or both. The anode catalyst coating layer, or the cathode catalyst coating layer, or both, comprises a catalyst, an ionomer, and optionally an additive. The anode catalyst coating layer, or the cathode catalyst coating layer, or both, are formed from a catalyst ink comprising a catalyst, an ionomer, a solvent, a porogen soluble in the solvent, and optionally an additive. The porogen may be removed from the layer of catalyst to create pores in the layer of catalyst as described above. By “adjacent,” is meant that the layers are next to one another, but not necessarily directly next to each other. For example, the first porous transfer layer is adjacent to one side of the ionically conductive membrane, but there is catalyst coating layer between them, which is on the membrane, on the porous transport layer, or both.

The catalysts, porogens, polymeric ionomers, additive, and ionically conductive membranes are described above.

In some embodiments, the membrane electrode assembly further comprises a pair of bipolar plates, one plate adjacent to the outside of the first porous transport layer and one plate adjacent to the outside of the second porous transport layer.

Another aspect is an electrolysis system. In one embodiment, the electrolysis system comprises: at least one cell forming a cell stack, the at least one cell comprising: a membrane electrode assembly, wherein the membrane electrode assembly comprises: an ionically conductive membrane; a first side of a first porous transport layer adjacent to a first side of the ionically conductive membrane; a first side of a second porous transport layer adjacent to a second side of the ionically conductive membrane: an anode between the first side of the ionically conductive membrane and the first side of the first porous transport layer, the anode comprising an anode catalyst coating layer on the first side surface of the ionically conductive membrane adjacent to the first porous transport layer, or on the first side of the first porous transport layer adjacent to the first side of the ionically conductive membrane, or both; a cathode between the second side of the ionically conductive membrane and a first side of the second porous transport layer, the cathode comprising a cathode catalyst coating layer on the second side of the ionically conductive membrane adjacent to the second porous transport layer, or on the first side of the second porous transport layer adjacent to the second side of the ionically conductive membrane, or both; wherein the anode catalyst coating layer, or the cathode catalyst coating layer, or both comprises a catalyst, an ionomer, and optionally an additive. The anode catalyst coating layer, or the cathode catalyst coating layer, or both are formed from an anode catalyst ink, or a cathode catalyst ink, or both, respectively. The electrolysis system may also comprise a pair of bipolar plates, a first bipolar plate adjacent to a second side of the first porous transport layer and a second bipolar plate adjacent to a second side of the second porous transport layer; and a pair of current collectors, a first current collector adjacent to a first end of the cell stack and a second current collector adjacent to a second end of the cell stack. The anode catalyst ink, or the cathode catalyst ink, or both comprise a catalyst, an ionomer, a solvent, a porogen soluble in the solvent, and optionally an additive. The porogen may be removed from the layer of catalyst to create pores in the layer of catalyst as described above.

The bipolar plates can be any bipolar plates known to those of skill in the art. Suitable bipolar plates include, but are not limited to Pt-coated Ti bipolar plate, stainless steel bipolar plate. Ti-coated stainless steel bipolar plate, Ti and C-coated stainless steel bipolar plate, stainless steel bipolar plate, graphite bipolar plate, or combinations thereof. The bipolar plates need to have high resistance to inhibit harmful ions out-diffusion from the bipolar plates and inhibit hydrogen adsorption embrittlement. The bipolar plates also need to have low and steady electrical contact resistance over the lifetime of the stack.

In some embodiments, there is a pair of gaskets, with the first gasket between the first porous transport layer and the first bipolar plate, and a second gasket between the second porous transport layer and the second bipolar plate.

The electrolysis system typically contains more than one cell. For example, the number of cells can be in the range of about 2 cells to several thousand cells, or in the range of about 2 cells to about 3000 cells, or in the range of about 2 cells to about 2000 cells, or in the range of about 2 cells to about 1500 cells, or in the range of about 2 cells to about 1000 cells, or in the range of about 2 cells to about 750 cells, or in the range of about 2 cells to about 500 cells, or in the range of about 10 cells to about 3000 cells, or in the range of about 10 cells to about 2000 cells, or in the range of about 10 cells to about 1500 cells, or in the range of about 10 cells to about 1000 cells, or in the range of about 10 cells to about 750 cells, or in the range of about 10 cells to about 500 cells, or in the range of about 20 cells to about 3000 cells, or in the range of about 20 cells to about 2000 cells, or in the range of about 20 cells to about 1500 cells, or in the range of about 20 cells to about 1000 cells, or in the range of about 20 cells to about 750 cells, or in the range of about 20 cells to about 500 cells. Multiple cells are stacked together forming a cell stack. Current collectors are positioned on each end of the cell stack, with end plates on the outside the current collectors on each end.

The current collectors can be any current collectors known to those of skill in the art. Suitable current collectors may be made of materials including, but not limited to nickel, steel, aluminum, copper, titanium, platinum and gold.

The end plates can be any end plates known to those of skill in the art. Suitable end plate materials include, but are not limited to aluminum alloy, stainless steel, Ti, and Pt-coated Ti.

The term “about” means within 10% of the value, or within 5%, or within 1%.

### EXAMPLES

### Example 1: Preparation of a Three-Layer MEA Comprising a PEM, an Anode Catalyst Coating Layer Formed from an Anode Catalyst Ink Comprising Glycerol Porogen, and a Cathode Catalyst Coating Layer (Abbreviated as 3-L MEA-Glycerol)

A three-layer MEA comprising a Fumasep® FS-990-PK PEM, an anode catalyst coating layer formed from an anode catalyst ink comprising IrO₂ catalyst, Nafion® ionomer, poly(3,4-ethylenedioxythiophene) (PEDOT) electron conductive polymer, and glycerol porogen in a mixture of water and ethanol solvents, and a cathode catalyst coating layer formed from a cathode catalyst ink comprising 40% Pt/C catalyst and Nafion® ionomer in a mixture of water and ethanol solvents (abbreviated as 3-L MEA-Glycerol) was prepared as the following:

An anode catalyst ink was prepared by mixing IrO₂ catalyst, glycerol porogen, a blend solution of PEDOT and poly(styrenesulfonate) (PSS) and Nafion® ionomer in H₂O and ethanol. The weight ratio of glycerol to IrO₂ catalyst is 1/10. The anode catalyst ink was coated on the first surface of the Fumasep® FS-990-PK PEM using a Mayer rod coating method and dried at 80° C. to form a 2-layer MEA comprising glycerol porogen in the IrO₂ anode catalyst coating layer. The IrO₂ loading was about 1.0 mg/cm².

A cathode catalyst ink was prepared by mixing 40% Pt/C catalyst and Nafion® ionomer in H₂O and ethanol. The mixture was finely dispersed using an ultrasonication bath. The cathode catalyst ink was coated onto the second surface of the Fumasep® FS-990-PK PEM using a Mayer rod coating method and dried at 80° C. to form a 3-layer MEA. The Pt loading was about 0.1 mg/cm².

The 3-layer MEA was soaked in a 0.1M H₂SO₄ acidic aqueous solution for 24 h, washed with ultra-pure water three times, and then air dried for 12 h to form 3-L MEA-Glycerol.

### Comparative Example 1. Preparation of a Three-Layer MEA Comprising a PEM, an Anode Catalyst Coating Layer Formed from an Anode Catalyst Ink without Glycerol Porogen, and a Cathode Catalyst Coating Layer (Abbreviated as 3-L MEA-Non-G)

A three-layer MEA comprising a Fumasep® FS-990-PK PEM, an anode catalyst coating layer formed from an anode catalyst ink comprising IrO₂ catalyst, Nafion® ionomer, and PEDOT electron conductive polymer in a mixture of water and ethanol solvents, and a cathode catalyst coating layer formed from a cathode catalyst ink comprising 40% Pt/C catalyst and Nafion® ionomer in a mixture of water and ethanol solvents (abbreviated as 3-L MEA-non-G) was prepared using the procedure of Example 1 except that the anode catalyst ink did not include glycerol porogen.

### Example 2. Evaluation of Water Electrolysis Performance of 3-L MEA-Non-G and 3-L MEA-Glycerol

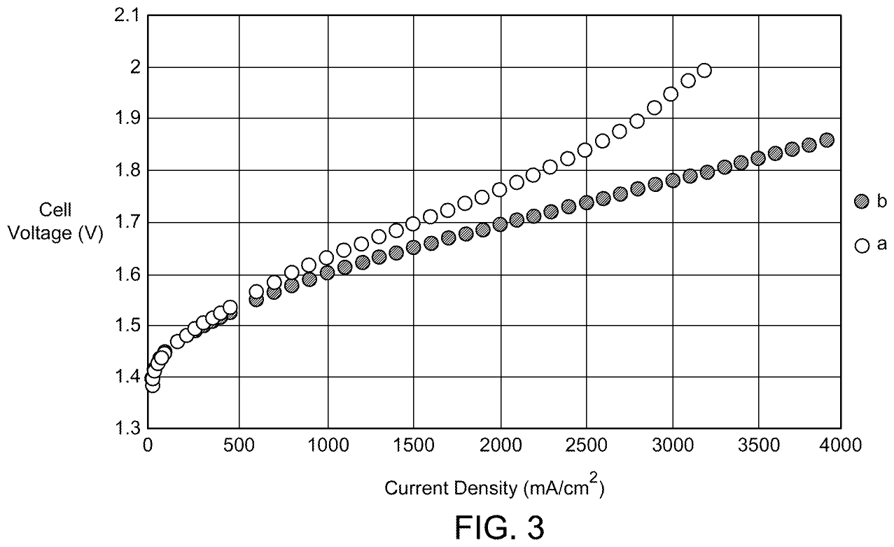

A proton exchange membrane (PEM) water electrolysis test station (Scribner 600 electrolyzer test system) was used to evaluate the water electrolysis performance of 3-L MEA-non-G (a) and 3-L MEA-Glycerol (b) MEAs in a single electrolyzer cell with an active membrane area of 5 cm². The test station included an integrated power supply, a potentiostat, an impedance analyzer for electrochemical impedance spectroscopy (EIS) and high-frequency resistance (HFR), and real-time sensors for product flow rate and crossover monitoring. The MEA was sandwiched between two Pt-coated Ti-felt porous transport layers (PTLs). The testing was conducted at 80° C. and at atmospheric pressure. Ultrapure water was supplied to the anode of the MEA with a flow rate of 100 mL/min. The polarization curve was collected at 80° C. and the results are shown in FIG. 3.

It can be observed from the polarization curves in FIG. 3 that the 3-L MEA-non-G MEA (a) made from an anode catalyst ink without any glycerol porogen showed significant mass transport resistance at greater than 2 A/cm² current density. Although not wishing to be bound by theory, this is most possibly due to the dense anode catalyst coating layer that resulted in the difficulty to remove the significant amount of gases generated at high current density. On the other hand, the 3-L MEA-Glycerol MEA prepared from an anode catalyst ink comprising the glycerol porogen demonstrated no mass transport resistance at greater than 2 A/cm² current density as shown in curve (b). In addition, the 3-L MEA-Glycerol MEA showed much lower cell voltage as shown in curve (b) than the 3-L MEA-non-G MEA made from an anode catalyst ink without any glycerol porogen as sown in curve (a) at greater than or equal to 1 A/cm² current density. These results indicate that 3-L MEA-Glycerol MEA with a more porous anode catalyst coating layer allowed fast removal of the gases generated at high current density, and no mass transport resistance was observed.

### SPECIFIC EMBODIMENTS

While the following is described in conjunction with specific embodiments, it will be understood that this description is intended to illustrate and not limit the scope of the preceding description and the appended claims.

A first embodiment of the invention is a catalyst ink comprising a catalyst; an ionomer; a solvent; a porogen soluble in the solvent; and optionally an additive. An embodiment of the invention is one, any or all of prior embodiments in this paragraph up through the first embodiment in this paragraph wherein the porogen comprises glycerol, glycine, ethylene glycol, poly(ethylene glycol), poly(ethylene oxide) (PEO), poly(propylene oxide) (PPO), co-block-poly(ethylene oxide)-poly(propylene oxide) (PEO-PPO), tri-block-poly(propylene oxide)-poly(ethylene oxide)-poly(propylene oxide) (PPO-PEO-PPO), sorbitol, polyvinylpyrrolidone (PVP), polyacrylic acid (PAA), diethylene glycol, sulfosuccinic acid, tetradecyltrimethylammonium bromide, tetramethylammonium bromide, tetradecyltrimethylammonium acetate, tetramethylammonium acetate, or combinations thereof. An embodiment of the invention is one, any or all of prior embodiments in this paragraph up through the first embodiment in this paragraph wherein the porogen comprises glycerol, glycine, ethylene glycol, diethylene glycol, sulfosuccinic acid, or combinations thereof. An embodiment of the invention is one, any or all of prior embodiments in this paragraph up through the first embodiment in this paragraph wherein the catalyst comprises iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof. An embodiment of the invention is one, any or all of prior embodiments in this paragraph up through the first embodiment in this paragraph wherein the catalyst comprises platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof. An embodiment of the invention is one, any or all of prior embodiments in this paragraph up through the first embodiment in this paragraph wherein the solvent comprises water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof. An embodiment of the invention is one, any or all of prior embodiments in this paragraph up through the first embodiment in this paragraph wherein the ionomer comprises a proton-conductive fluorinated or non-fluorinated polymeric ionomer or a hydroxide-conductive polymeric ionomer, or combinations thereof. An embodiment of the invention is one, any or all of prior embodiments in this paragraph up through the first embodiment in this paragraph wherein the additive comprises an electron conductive polymer.

A second embodiment of the invention is a catalyst coated membrane comprising a membrane: a layer of catalyst on a first surface of the membrane, wherein the catalyst layer comprises a catalyst; an ionomer; and optionally an additive; wherein the catalyst layer is formed from a catalyst ink comprising a catalyst; an ionomer; a solvent; a porogen soluble in the solvent; and optionally an additive. An embodiment of the invention is one, any or all of prior embodiments in this paragraph up through the second embodiment in this paragraph further comprising a layer of catalyst on a second surface of the membrane. An embodiment of the invention is one, any or all of prior embodiments in this paragraph up through the second embodiment in this paragraph wherein the catalyst layer on the second surface comprises a catalyst; an ionomer; and optionally an additive; wherein the catalyst layer is formed from a catalyst ink comprising a catalyst; an ionomer; a solvent; a porogen soluble in the solvent; and optionally an additive. An embodiment of the invention is one, any or all of prior embodiments in this paragraph up through the second embodiment in this paragraph wherein the porogen comprises glycerol, glycine, ethylene glycol, poly(ethylene glycol), poly(ethylene oxide) (PEO), poly(propylene oxide) (PPO), co-block-poly(ethylene oxide)-poly(propylene oxide) (PEO-PPO), tri-block-poly(propylene oxide)-poly(ethylene oxide)-poly(propylene oxide) (PPO-PEO-PPO), sorbitol, polyvinylpyrrolidone (PVP), polyacrylic acid (PAA), diethylene glycol, sulfosuccinic acid, tetradecyltrimethylammonium bromide, tetramethylammonium bromide, tetradecyltrimethylammonium acetate, tetramethylammonium acetate, or combinations thereof. An embodiment of the invention is one, any or all of prior embodiments in this paragraph up through the second embodiment in this paragraph wherein the catalyst comprises iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof. An embodiment of the invention is one, any or all of prior embodiments in this paragraph up through the second embodiment in this paragraph wherein the catalyst comprises platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof. An embodiment of the invention is one, any or all of prior embodiments in this paragraph up through the second embodiment in this paragraph wherein the solvent comprises water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof. An embodiment of the invention is one, any or all of prior embodiments in this paragraph up through the second embodiment in this paragraph wherein the additive comprises an electron conductive polymer. An embodiment of the invention is one, any or all of prior embodiments in this paragraph up through the second embodiment in this paragraph wherein the ionomer comprises a proton-conductive fluorinated or non-fluorinated polymeric ionomer or a hydroxide-conductive polymeric ionomer, or combinations thereof. An embodiment of the invention is one, any or all of prior embodiments in this paragraph up through the second embodiment in this paragraph wherein the membrane comprises a proton-exchange membrane or an anion-exchange membrane.

A third embodiment of the invention is a method of making a catalyst coated membrane comprising coating a layer of catalyst ink on a first surface of a membrane to form a coated membrane, the catalyst ink comprising a catalyst; an ionomer; a porogen; a solvent: and optionally an additive: drying the layer of catalyst ink to form a catalyst layer on the first surface of the membrane; and removing the porogen from the catalyst layer to create pores in the catalyst layer. An embodiment of the invention is one, any or all of prior embodiments in this paragraph up through the third embodiment in this paragraph wherein removing the porogen from the layer of catalyst comprises soaking the coated membrane in a solvent, an acidic solution, or a basic solution or washing the coated membrane with a solvent, an acidic solution, or a basic solution.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A catalyst ink comprising:
a catalyst;
an ionomer;
a solvent;
a porogen soluble in the solvent; and
optionally an additive.

2. The catalyst ink of claim 1 wherein the porogen comprises glycerol, glycine, ethylene glycol, poly(ethylene glycol), poly(ethylene oxide) (PEO), poly(propylene oxide) (PPO), co-block-poly(ethylene oxide)-poly(propylene oxide) (PEO-PPO), tri-block-poly(propylene oxide)-poly(ethylene oxide)-poly(propylene oxide) (PPO-PEO-PPO), sorbitol, polyvinylpyrrolidone (PVP), polyacrylic acid (PAA), diethylene glycol, sulfosuccinic acid, tetradecyltrimethylammonium bromide, tetramethylammonium bromide, tetradecyltrimethylammonium acetate, tetramethylammonium acetate, or combinations thereof.

3. The catalyst ink of claim 1 wherein the porogen comprises glycerol, glycine, ethylene glycol, diethylene glycol, sulfosuccinic acid, or combinations thereof.

4. The catalyst ink of claim 1 wherein the catalyst comprises iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof.

5. The catalyst ink of claim 1 wherein the catalyst comprises platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof.

6. The catalyst ink of claim 1 wherein the solvent comprises water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof.

7. The catalyst ink of claim 1 wherein the ionomer comprises a proton-conductive fluorinated or non-fluorinated polymeric ionomer or a hydroxide-conductive polymeric ionomer, or combinations thereof.

8. The catalyst ink of claim 1 wherein the additive comprises an electron conductive polymer.

9. A catalyst coated membrane comprising:
a membrane;
a layer of catalyst on a first surface of the membrane, wherein the catalyst layer comprises:
a catalyst;
an ionomer; and
optionally an additive;
wherein the catalyst layer is formed from a catalyst ink comprising:
a catalyst;
an ionomer;
a solvent;
a porogen soluble in the solvent; and
optionally an additive.

10. The catalyst coated membrane of claim 9 further comprising a layer of catalyst on a second surface of the membrane.

11. The catalyst coated membrane of claim 10 wherein the catalyst layer on the second surface comprises:
a catalyst;
an ionomer; and
optionally an additive;
wherein the catalyst layer is formed from a catalyst ink comprising:
a catalyst;
an ionomer;
a solvent;
a porogen soluble in the solvent; and
optionally an additive.

12. The catalyst coated membrane of claim 9 wherein the porogen comprises glycerol, glycine, ethylene glycol, poly(ethylene glycol), poly(ethylene oxide) (PEO), poly(propylene oxide) (PPO), co-block-poly(ethylene oxide)-poly(propylene oxide) (PEO-PPO), tri-block-poly(propylene oxide)-poly(ethylene oxide)-poly(propylene oxide) (PPO-PEO-PPO), sorbitol, polyvinylpyrrolidone (PVP), polyacrylic acid (PAA), diethylene glycol, sulfosuccinic acid, tetradecyltrimethylammonium bromide, tetramethylammonium bromide, tetradecyltrimethylammonium acetate, tetramethylammonium acetate, or combinations thereof.

13. The catalyst coated membrane of claim 9 wherein the catalyst comprises iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof.

14. The catalyst coated membrane of claim 9 wherein the catalyst comprises platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof.

15. The catalyst coated membrane of claim 9 wherein the solvent comprises water, alcohol, acetone, methyl ethyl ketone, ether, tetrahydrofuran, 1,3-dioxolane, methyl acetate, ethyl acetate, dimethyl sulfoxide, dimethylacetamide, dimethylformamide, or combinations thereof.

16. The catalyst coated membrane of claim 9 wherein the additive comprises an electron conductive polymer.

17. The catalyst coated membrane of claim 9 wherein the ionomer comprises a proton-conductive fluorinated or non-fluorinated polymeric ionomer or a hydroxide-conductive polymeric ionomer, or combinations thereof.

18. The catalyst coated membrane of claim 9 wherein the membrane comprises a proton-exchange membrane or an anion-exchange membrane.

19. A method of making a catalyst coated membrane comprising:
coating a layer of catalyst ink on a first surface of a membrane to form a coated membrane, the catalyst ink comprising:
a catalyst;
an ionomer;
a porogen;
a solvent; and
optionally an additive;
drying the layer of catalyst ink to form a catalyst layer on the first surface of the membrane; and
removing the porogen from the catalyst layer to create pores in the catalyst layer.

20. The method of claim 19 wherein removing the porogen from the layer of catalyst comprises soaking the coated membrane in a solvent, an acidic solution, or a basic solution or washing the coated membrane with a solvent, an acidic solution, or a basic solution.
